(19) United States
(12) Patent Application Publication
(10) Pub. No.: US 2023/0345320 A1
(43) Pub. Date: Oct. 26, 2023

(54) METHOD AND APPARATUS FOR SUPPORTING DIRECT COMMUNICATION PATH FROM PC5 TO UU IN A WIRELESS COMMUNICATION SYSTEM

(71) Applicant: ASUS Technology Licensing Inc., Taipei City (TW)

(72) Inventor: Richard Lee-Chee Kuo, Taipei City (TW)

(21) Appl. No.: 18/125,186

(22) Filed: Mar. 23, 2023

Related U.S. Application Data
(60) Provisional application No. 63/334,400, filed on Apr. 25, 2022.

(51) Int. Cl. H04W 36/00

(52) U.S. Cl. CPC H04W 36/00837; H04W 36/0094; H04W 92/18

(57) ABSTRACT

A method and device are disclosed for supporting a communication path switching from PC5 to Uu. In one embodiment, the method includes a second User Equipment (UE) communicating with a first UE via a PC5 unicast link established between the first UE and the second UE. The method also includes the second UE receiving a path switch request message from the first UE, wherein the path switch request message indicates a path switching to Uu. The method further includes the second UE determining to accept the path switch request message according to at least a Uu signal level. In addition, the method includes the second UE transmitting a path switch accept message to the first UE.

### CROSS-REFERENCE TO RELATED APPLICATIONS

The present Application claims the benefit of U.S. Provisional Patent Application Ser. No. 63/334,400 filed on Apr. 25, 2022, the entire disclosure of which is incorporated herein in its entirety by reference.

### FIELD

This disclosure generally relates to wireless communication networks, and more particularly, to a method and apparatus for supporting direct communication path PC5 to Uu in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device are disclosed for supporting a communication path switching from PC5 to Uu. In one embodiment, the method includes a second User Equipment (UE) communicating with a first UE via a PC5 unicast link established between the first UE and the second UE. The method also includes the second UE receiving a path switch request message from the first UE, wherein the path switch request message indicates a path switching to Uu. The method further includes the second UE determining to accept the path switch request message according to at least a Uu signal level. In addition, the method includes the second UE transmitting a path switch accept message to the first UE.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 5.3.1-1 of 3GPP TR 23.700-33 V0.2.0.

FIG. 6 is a reproduction of FIG. 6.16.2-2 of 3GPP TR 23.700-33 V0.2.0.

FIG. 7 is a reproduction of FIG. 6.17.2-1 of 3GPP TR 23.700-33 V0.2.0.

FIG. 8 is a reproduction of FIG. 6.18.2-1 of 3GPP TR 23.700-33 V0.2.0.

FIG. 9 is a reproduction of FIG. 6.3.3.1-1 of 3GPP TS 23.287 V17.1.0.

FIG. 10 illustrates communication path switching from PC5 to Uu according to one exemplary embodiment.

FIG. 11 is a flow diagram according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TR 23.700-33 V0.2.0, “Study on system enhancement for Proximity based services (ProSe) in the 5G System (5GS); Stage 2 (Release 18)”; and 3GPP TS 23.287 V17.1.0, “Architecture enhancements for 5G System (5GS) to support Vehicle-to-Everything (V2X) services (Release 17)”. The standards and documents listed above are hereby expressly incorporated by reference in their entirety.

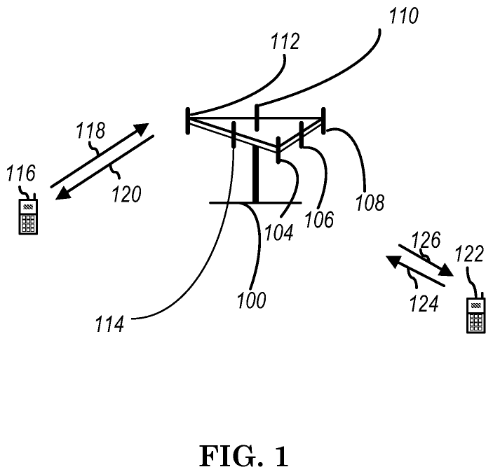

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

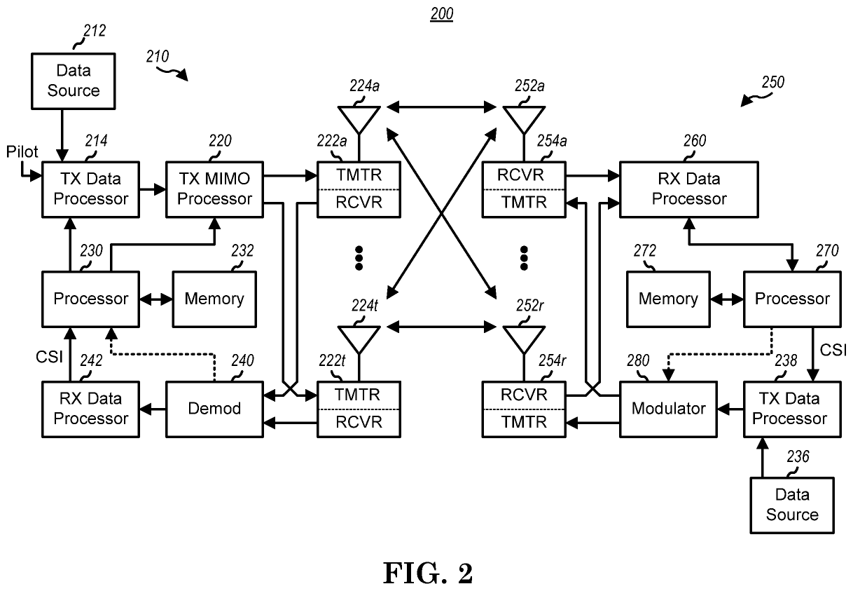

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

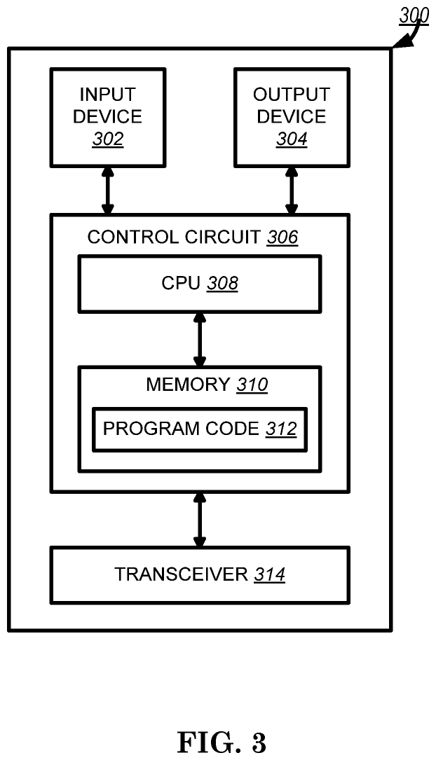

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the N_{R} system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

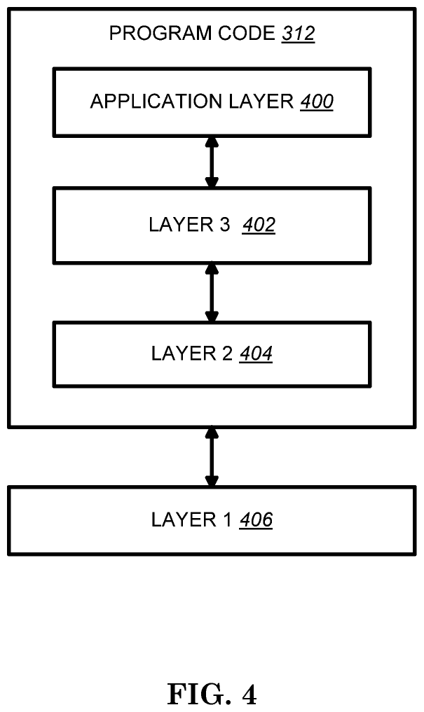

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TR 23.700-33 is a technical report for study on system enhancement for Proximity based Services (ProSe) in the 5G System (5GS). Key issue #3 in the technical report (provided in 3GPP TR 23.700-33 V0.2.0) and related solutions for the issue are provided below:

5.3 Key Issue #3: Support direct communication path switching between PC5 and Uu (i.e. non-relay case)

5.3.1 General Description

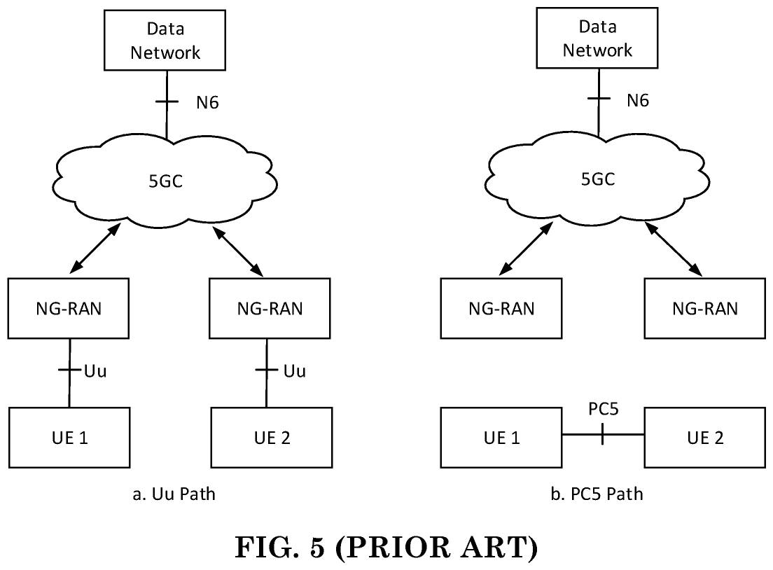

As illustrated in FIG. 5.3.1-1, the “direct communication path switching between PC5 and Uu reference points” refers to the procedure on how a UE switches between direct Uu communication path and direct PC5 communication path when it is communicating with another UE. The direct communication path over PC5 reference point means that the communication with another UE is performed by using 5G ProSe Direct Communication only. The direct communication path over Uu reference point means that the communication with another UE is performed via the network.

### FIG. 5.3.1-1 of 3GPP TR 23.700-33 V0.2.0, Entitled “Example Scenario of Direct Communication Path Switching Between PC5 and Uu (i.e. Switching Between Figure a and Figure b)”, is Reproduced as FIG. 5

When switching the path between the direct communication path over PC5 reference point and the direct communication path over Uu reference point, the ProSe service disruption to the UE should be minimized.

This key issue addresses the following:
Whether and how to support path switching from direct N_{R} Uu communication path to direct N_{R} PC5 communication path or vice versa for both commercial and public safety services.
   How to support any IP, Ethernet or Unstructured PDU type for direct communication path switching.
   What functional entities and triggers are responsible for direct communication path switching and their impact on the corresponding interfaces. What information/policy are used for path switching decision.
   What are the procedures and potential impacts of direct communication path switching on QoS handling for direct PC5 communication path vs. direct Uu communication path?
NOTE: No RAN dependency is expected for key issue.

6.16 Solution #16: Provisioning policy based direct communication path switching between PC5 and Uu reference points

6.16.1 Description

This solution resolves Key Issue #3 “Support direct communication path switching between PC5 and Uu (i.e. non-relay case)” and Key Issue #6 “Support of PC5 Service Authorization and Policy/Parameter Provisioning”.

The “direct communication path switching between direct PC5 and direct Uu reference points” refers to the procedure on how a UE switches the direct communication paths between PC5 reference point and Uu reference point when it is communicating with another UE. The direct communication path over direct PC5 reference point means that the communication with another UE is performed by using 5G ProSe Direct Communication only. The direct communication path over Uu reference point means that the communication with another UE is performed via the network (i.e. non-relay case) and the communication via 5G ProSe UE-to-Network Relay (Layer-2 or Layer-3) is not considered.
NOTE 1: Session continuity (e.g. IP address preservation) is not supported during path switching in this solution.

Path switching policy is provided to the UE to indicate which path(s) is allowed for all or specific ProSe services (i.e. direct PC5 allowed, direct Uu allowed or no allowed indicated). The path switching policy is defined as the mapping of ProSe services (i.e. ProSe identifiers) to path allowed (i.e. direct PC5 allowed, direct Uu allowed, or no allowed) and the path switching policy can be a one mapping for all ProSe services (i.e. same path allowed for all ProSe services). The path switching policy can be (pre-) configured in the UE or provided by the PCF. The ProSe Application Server may provide a path allowed indication for ProSe Services to UDR and this may be used by PCF for path switching policy generation and update.

The UE may use the pre-configured/provisioned path switching policy to switching all or specific ProSe services to the appropriate communication path. The “Procedures for Service Authorization and Provisioning to UE” as defined in TS 23.304 [3] is reused for provisioning path switching policy to the UE.

The UE evaluates the path switching policy and switches the communication path as below:
If direct PC5 allowed is indicated, the UE may switch to the direct PC5 reference point for communication path for the ProSe service.
If direct Uu allowed is indicated, the UE may switch to the direct Uu reference point for communication path for the ProSe service.
If no allowed is indicated or no path switching policy is provisioned, the UE may switch to either a direct Uu or direct PC5 communication path based on its pre-configuration or implementation for the ProSe service.
NOTE 2: The path switching policy is used to determine whether a communication path can be switched when a UE is communicating with another UE, so it is different to the path selection policy as defined in TS 23.304 [3].

Based on the path switching policy, a UE may establish a PDU session or a PC5 connection in the target path and switch the traffic from the source path to the target path. The service continuity during path switching can be achieved by the application layer mechanism.

6.16.2 Procedures

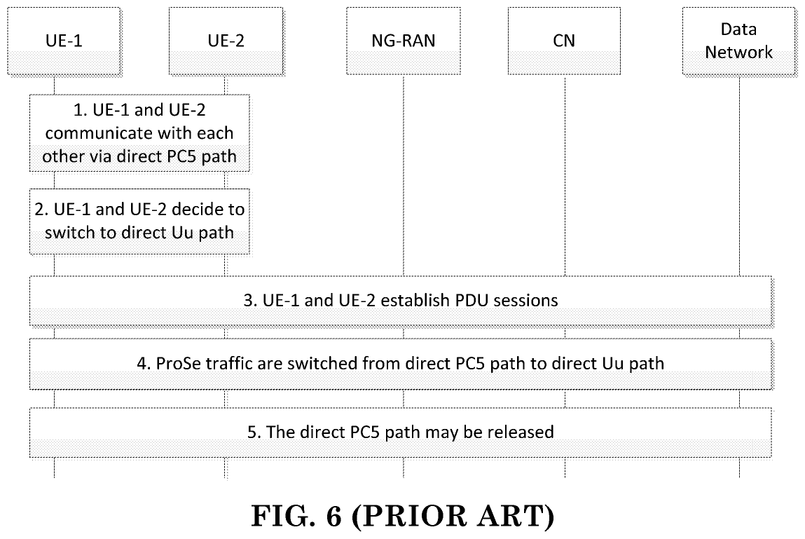

FIG. 6.16.2-2 depicts the procedure on direct PC5 to direct Uu path switching.

### FIG. 6.16.2-2 of 3GPP TR 23.700-33 V0.2.0, Entitled “Procedure on Direct PC5 to Direct Uu Path Switching”, is Reproduced as FIG. 6

1. UE-1 and UE-2 establish PC5 connection and communicate with each other via the direct PC5 path.
2. The UE-1 and UE-2 may decide to switch ProSe services from direct PC5 path to direct Uu path, due to, e.g. UE-1 and UE-2 are moving far with each other.
UE-1 and UE-2 determine whether the ProSe services can be switched based on path switching policy as described in clause 6.16.1.
3. UE-1 and UE-2 establish PDU sessions by reusing the PDU session establishment procedure as described in clause 4.3.2 of TS 23.502 [8].
4. The ProSe services are switched from direct PC5 path to direct Uu path.
5. The PC5 connection may be released if no traffic transmitted over the PC5 connection.

6.17 Solution #17: Path Switching from PC5 Path to Uu Path

6.17.1 Description

This solution resolves Key Issue #3 for direct communication path switching from PC5 path to Uu path.

This solution uses the make-before-break mechanism to reduce interruption when path switch from PC5 to Uu. The two UEs perform the Uu path preparation procedure for the switched service, and then may release the PC5 connection. During the Uu path preparation procedure phase, the two UEs may negotiate, using the ProSe layer, the Uu QoS based on PC5 QoS via the PC5 connection in order to ensure consistent service experience, and optionally share the IP address used for the Uu path to each other to achieve the switch of service transmission.

6.17.2 Procedures

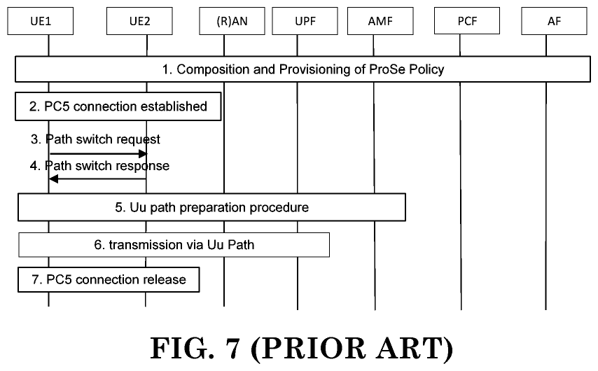

### FIG. 6.17.2-1 of 3GPP TR 23.700-33 V0.2.0, Entitled “High-Level Procedure for Path Switch from PC5 to Uu”, is Reproduced as FIG. 7

1. Triggered by an AF request, the PCF may provide the path switch Policy/parameters for Proximity Services to the UE (including UE1 and UE2) by using the procedure as defined in clause 4.2.4.3 in TS 23.502 [8]. The path switch Policy/parameters may include whether the specific service (e.g. Service A) is allowed to switch from PC5 to Uu.
2. UE1 and UE2 have an established PC5 connection and are transferring service data with each other for Service A. Before the PC5 connection establishment, UE1 and UE2 may get the path selection policy, which indicates that the PC5 path is preferred for Service A.
3. When e.g. the PC5 signal level is lower than the configured threshold or PC5 QoS for Service A cannot be satisfied, UE1 sends the path switch request for Service A to UE2. The request message includes the Service A identifier. Before UE1 sends the request, UE1 checks the path switch Policy/parameters to make sure that Service A is allowed to switch from PC5 to Uu.
4. UE2 sends the path switch response to UE1 that indicates that Service A can be switched to Uu path. The response message includes the Service A identifier. Before UE2 sends the response, UE2 checks the path switch Policy/parameters to make sure that Service A is allowed to switch from PC5 to Uu.
NOTE: PC5 connection is still valid to transfer the PC5 signalling in step 3 and step 4.
5. UE1 and UE2 perform the Uu path preparation procedure. In particular, UE1 and UE2 each trigger PDU Session establishment/modification procedure, if needed, to make the Uu path ready for Service A transmission. During this procedure UE1 and UE2 can get the IP address of the PDU session that will be used for the Service A, and UE1 and UE2 can respectively request the Uu QoS 1 (used for Uu path of UE1) and Uu QoS 2 (used for Uu path of UE2) for Service A.
Before UE1 and UE2 request the Uu QoS for Service A, UE1 decides the Uu QoS 1 and Uu QoS 2 requirements for Service A based on PC5 QoS requirement for Service A and sends Uu QoS 2 requirements to UE2 via the PC5 connection. Uu QoS 1 and Uu QoS 2 requirements can be decided based on the configured mapping of PC5 QoS parameter to Uu QoS parameter or based on UE1 implementation.
Optionally, UE1 and UE2 can also share the IP/port addresses used for Uu path with each other via the PC5 connection, to achieve the switch of the Service A transmission.
6. UE1 and UE2 transmit the data of the Service A via the Uu path.
7. After the step 6, UE1 and UE2 may release the PC5 connection, using the existing Layer-2 link release over PC5 reference point, see clause 6.4.3.3 of TS 23.304 [3].
Editor's note: How to support Ethernet traffic and Unstructured traffic is FFS.

6.18 Solution #18: UE Negotiation-Based Path Switching from PC5 to Uu

6.18.1 Description

This is a solution related to the Key Issue #3 Support direct communication path switching between PC5 and Uu reference points.

This solution provides a UE Negotiation-Based mechanism for the direct communication path switching between PC5 to Uu reference points. Before performing the path switch, 2 UEs having PC5 connection negotiate the triggers of path switching and what service or QoS flows need to be switched. Once the negotiated triggers are satisfied, the 2 UEs perform the path switching between PC5 to Uu directly. To reduce the service interruption, the principle of “make before break” may be adopted, the 2 UEs may perform corresponding Uu session setup/activation in advance after the UE Negotiation-Based mechanism over PC5 for the path switching from PC5 to Uu interface. For the path switching from the Uu to PC5 interface, it requires that the 2 UEs establish the PC5 link firstly, then negotiate the ProSe services to be switched over the established PC5 link. After that, the 2 UEs perform the path switching based on the negotiated result.

During the negotiation procedure, the 2 UEs may negotiate:
Which ProSe service to be switched;
Which QoS flow(s) to be switched;
Triggers of path switching from PC5 to Uu about:
   Threshold of PC5 signal level;
   Threshold of QoS requirement/parameters.
NOTE 1: In this solution, the negotiation can be triggered by UE implementation from the its own service requirement perspective.
NOTE 2: Granularity of this solution for path switching can be service level and QoS flow level.

Due to UE mobility or its own conditions (e.g. under congestion control, mobility restriction), the UE can not perform the path switch, then the UE may notify the peer UE of deactivating the negotiated triggers or UE ProSe policy of path switching to avoid the peer UE performing path switch solely.

6.18.2 Procedures for Path Switching from PC5 to Uu with Negotiation

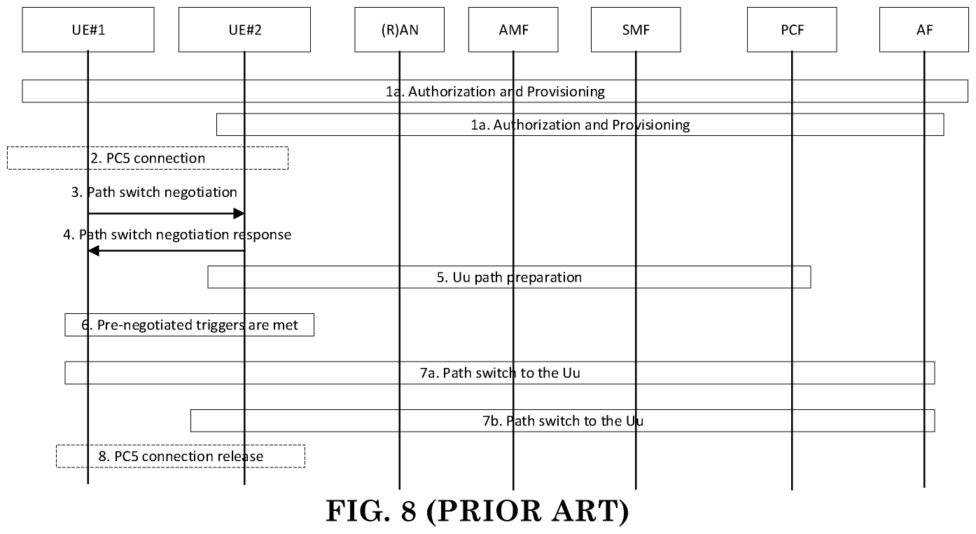

### FIG. 6.18.2-1 of 3GPP TR 23.700-33 V0.2.0, Entitled “High-Level Procedure for Path Switch from PC5 to Uu with Negotiation”, is Reproduced as FIG. 8

1. Service authorization and provisioning are performed for the UE #1 and UE #2 as described in clause 6.2 of TS 23.304 [3].
2. UE #1 and UE #2 may have an established PC5 connection which are transferring service data with each other over PC5 QoS flows.
3. Considering to avoid service interruption, UE #1 and UE #2 may consider the path switch from PC5 to Uu. In order to have a uniform understanding for the path switch, the 2 UEs negotiate the path switching services, QoS flows and the triggers of the service or QoS flows to be switched. UE #1 sends a Path switching negotiation request which may include the ProSe ID, PC5 QoS flows IDs, Threshold of PC5 signal level, or Threshold of QoS requirement/parameters. This step can be combined with PC5 unicast connection establishment/modification procedure.
4. After receiving the above request from UE #1, UE #2 determines that services, QoS flows triggers and related triggers based on the Path switching negotiation request from the UE #1. The UE #2 responds to the UE #1 with a Path switching negotiation response including the accepted ProSe ID, PC5 QoS flows IDs, Threshold of PC5 signal level, or Threshold of QoS requirement/parameters.
5. Based on the negotiation, the UE #1 and UE #2 may perform the Uu path preparation procedure. UE1 and UE2 triggers PDU Session establishment/modification procedure to make the Uu path ready for the corresponding ProSe services or PC5 QoS flows transmission.
6-7. When the negotiated triggers/conditions are satisfied, the UE #1 and UE #2 transmit the data of the ProSe services of accepted ProSe IDs or the PC5 QoS flows of the accepted PC5 QoS flow IDs to the Uu path.
8. After the step 7, UE1 and UE2 may release the PC5 connection, using the existing Layer-2 link release over PC5 reference point, see clause 6.4.3.3 of TS 23.304 [3].

UE #1 and UE #2 may update the negotiated triggers after the negation procedure.

3GPP TS 23.287 specifies Layer-2 link establishment over PC5 reference point as follows:

6.3.3.1 Layer-2 link establishment over PC5 reference point

To perform unicast mode of V2X communication over PC5 reference point, the UE is configured with the related information as described in clause 5.1.2.1.

FIG. 6.3.3.1-1 shows the layer-2 link establishment procedure for unicast mode of V2X communication over PC5 reference point.

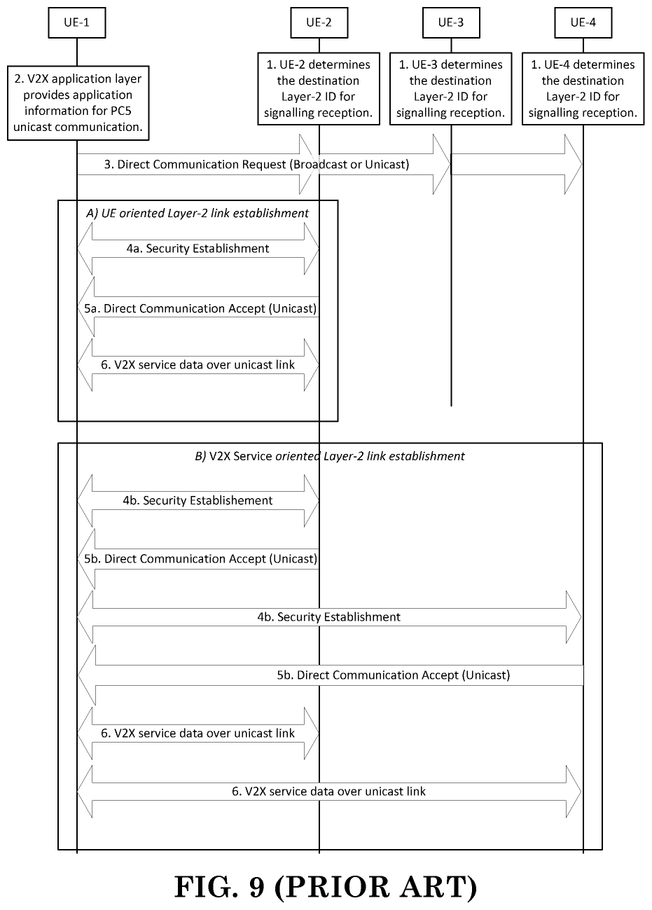

### FIG. 6.3.3.1-1 of 3GPP TS 23.287 V17.1.0, Entitled “Layer-2 Link Establishment Procedure”, is Reproduced as FIG. 9

1. The UE(s) determine the destination Layer-2 ID for signalling reception for PC5 unicast link establishment as specified in clause 5.6.1.4. The destination Layer-2 ID is configured with the UE(s) as specified in clause 5.1.2.1.
2. The V2X application layer in UE-1 provides application information for PC5 unicast communication. The application information includes the V2X service type(s) and the initiating UE's Application Layer ID. The target UE's Application Layer ID may be included in the application information.
The V2X application layer in UE-1 may provide V2X Application Requirements for this unicast communication. UE-1 determines the PC5 QoS parameters and PFI as specified in clause 5.4.1.4.
If UE-1 decides to reuse the existing PC5 unicast link as specified in clause 5.2.1.4, the UE triggers Layer-2 link modification procedure as specified in clause 6.3.3.4.
3. UE-1 sends a Direct Communication Request message to initiate the unicast layer-2 link establishment procedure. The Direct Communication Request message includes:
   Source User Info: the initiating UE's Application Layer ID (i.e. UE-Vs Application Layer ID).
   If the V2X application layer provided the target UE's Application Layer ID in step 2, the following information is included:
      Target User Info: the target UE's Application Layer ID (i.e. UE-2's Application Layer ID).
   V2X Service Info: the information about V2X service type(s) requesting Layer-2 link establishment.
   Security Information: the information for the establishment of security.
NOTE 1: The Security Information and the necessary protection of the Source User Info and Target User Info are defined in TS 33.536 [26].
   The source Layer-2 ID and destination Layer-2 ID used to send the Direct Communication Request message are determined as specified in clauses 5.6.1.1 and 5.6.1.4. The destination Layer-2 ID may be broadcast or unicast Layer-2 ID. When unicast Layer-2 ID is used, the Target User Info shall be included in the Direct Communication Request message.
   UE-1 sends the Direct Communication Request message via PC5 broadcast or unicast using the source Layer-2 ID and the destination Layer-2 ID.
4. Security with UE-1 is established as below:
   4a. If the Target User Info is included in the Direct Communication Request message, the target UE, i.e. UE-2, responds by establishing the security with UE-1.
   4b. If the Target User Info is not included in the Direct Communication Request message, the UEs that are interested in using the announced V2X service type(s) over a PC5 unicast link with UE-1 responds by establishing the security with UE-1.
NOTE 2: The signalling for the Security Procedure is defined in TS 33.536 [26].
   When the security protection is enabled, UE-1 sends the following information to the target UE:
   If IP communication is used:
      IP Address Configuration: For IP communication, IP address configuration is required for this link and indicates one of the following values:
         “IPv6 Router” if IPv6 address allocation mechanism is supported by the initiating UE, i.e., acting as an IPv6 Router; or
         “IPv6 address allocation not supported” if IPv6 address allocation mechanism is not supported by the initiating UE.
      Link Local IPv6 Address: a link-local IPv6 address formed locally based on RFC 4862 [21] if UE-1 does not support the IPv6 IP address allocation mechanism, i.e. the IP Address Configuration indicates “IPv6 address allocation not supported”.
   QoS Info: the information about PC5 QoS Flow(s) to be added. For each PC5 QoS Flow, the PFI, the corresponding PC5 QoS parameters (i.e. PQI and conditionally other parameters such as MFBR/GFBR, etc.) and the associated V2X service type(s).
The source Layer-2 ID used for the security establishment procedure is determined as specified in clauses 5.6.1.1 and 5.6.1.4. The destination Layer-2 ID is set to the source Layer-2 ID of the received Direct Communication Request message.
Upon receiving the security establishment procedure messages, UE-1 obtains the peer UE's Layer-2 ID for future communication, for signalling and data traffic for this unicast link.
5. A Direct Communication Accept message is sent to UE-1 by the target UE(s) that has successfully established security with UE-1:
   5a. (UE oriented Layer-2 link establishment) If the Target User Info is included in the Direct Communication Request message, the target UE, i.e. UE-2 responds with a Direct Communication Accept message if the Application Layer ID for UE-2 matches.
   5b. (V2X Service oriented Layer-2 link establishment) If the Target User Info is not included in the Direct Communication Request message, the UEs that are interested in using the announced V2X Service(s) respond to the request by sending a Direct Communication Accept message (UE-2 and UE-4 in FIG. 6.3.3.1-1).
   The Direct Communication Accept message includes:
      Source User Info: Application Layer ID of the UE sending the Direct Communication Accept message.
      QoS Info: the information about PC5 QoS Flow(s) requested by UE-1. For each PC5 QoS Flow, the PFI, the corresponding PC5 QoS parameters (i.e. PQI and conditionally other parameters such as MFBR/GFBR, etc.) and the associated V2X service type(s).
      If IP communication is used:
         IP Address Configuration: For IP communication, IP address configuration is required for this link and indicates one of the following values:
         “IPv6 Router” if IPv6 address allocation mechanism is supported by the target UE, i.e., acting as an IPv6 Router; or
         “IPv6 address allocation not supported” if IPv6 address allocation mechanism is not supported by the target UE.
      Link Local IPv6 Address: a link-local IPv6 address formed locally based on RFC 4862 [21] if the target UE does not support the IPv6 IP address allocation mechanism, i.e. the IP Address Configuration indicates “IPv6 address allocation not supported”, and UE-1 included a link-local IPv6 address in the Direct Communication Request message. The target UE shall include a non-conflicting link-local IPv6 address.
   If both UEs (i.e. the initiating UE and the target UE) selected to use link-local IPv6 address, they shall disable the duplicate address detection defined in RFC 4862 [21].
NOTE 3: When either the initiating UE or the target UE indicates the support of IPv6 router, corresponding address configuration procedure would be carried out after the establishment of the layer 2 link, and the link-local IPv6 addresses are ignored.
   The V2X layer of the UE that established PC5 unicast link passes the PC5 Link Identifier assigned for the unicast link and the PC5 unicast link related information down to the AS layer. The PC5 unicast link related information includes Layer-2 ID information (i.e. source Layer-2 ID and destination Layer-2 ID) and the corresponding PC5 QoS parameters. This enables the AS layer to maintain the PC5 Link Identifier together with the PC5 unicast link related information.
6. V2X service data is transmitted over the established unicast link as below:
   The PC5 Link Identifier, and PFI are provided to the AS layer, together with the V2X service data.
   Optionally in addition, the Layer-2 ID information (i.e. source Layer-2 ID and destination Layer-2 ID) is provided to the AS layer.
NOTE 4: It is up to UE implementation to provide the Layer-2 ID information to the AS layer.
   UE-1 sends the V2X service data using the source Layer-2 ID (i.e. UE-1's Layer-2 ID for this unicast link) and the destination Layer-2 ID (i.e. the peer UE's Layer-2 ID for this unicast link).
NOTE 5: PC5 unicast link is bi-directional, therefore the peer UE of UE-1 can send the V2X service data to UE-1 over the unicast link with UE-1.

Key issue #3 in 3GPP TR 23.700-33 describes support of direct communication path switching between PC5 and Uu (i.e. non-relay case). The direct communication path over PC5 reference point means that the communication (associated with a service) between two concerned UEs is performed via a PC5 unicast link (or a Layer-2 link) established between these two UEs. The direct communication path over Uu reference point means that the communication between two concerned UEs is performed via a data network. Basically, each UE establishes a Protocol Data Unit (PDU) session (associated with the service) with the data network and then communicates with each other via the established PDU sessions.

According to Step 3 of FIG. 6.17.2-1 (reproduced as FIG. 7 of the present application) of 3GPP TR 23.700-33, to initiate a path switch from PC5 to Uu, UE1 sends a path switch request for a service to UE2 if the PC5 signal level is lower than a configured threshold or the PC5 QoS for the service cannot be satisfied. However, if the Uu signal level is much lower or the service quality (i.e. QoS) over the Uu path is worse than that over the PC5 path, it would not make sense to switch the communication path to Uu. Therefore, the Uu signal level should also be taken into consideration before initiating the communication path switch from PC5 to Uu. In other words, UE1 should determine whether to switch the communication path from PC5 to Uu according to at least the PC5 signal level and the Uu signal level. For example, UE1 may determine to switch the communication path from PC5 to Uu if the PC5 signal level is lower than a first threshold (associated with the ongoing service) and the Uu signal level is higher than (or equal to) a second threshold (associated with the ongoing service). The UE may first check whether path switch to Uu is allowed (e.g. according to the path switch policy) like Step 1 in FIG. 6.17.2-1 (reproduced as FIG. 7 of the present application). The threshold values may be shared by all services or each service is associated with a threshold value. In one embodiment, these threshold values could be preconfigured by the network or broadcasted in system information.

After UE1 determines to switch the communication path from PC5 to Uu, UE1 may transmit a path switch request to UE2. To ensure the communication path switch from PC5 to Uu can be successful, there is also a need for UE2 to check whether its Uu signal level is good enough to support the ongoing service before accepting the path switch request. For example, the Uu signal level is higher than or equal to a third threshold (associated with the ongoing service), the Uu signal level is higher than a PC5 signal level, or the Uu signal level is higher than the PC5 signal level plus a fourth threshold. Otherwise, UE2 should reject the path switch request. In one embodiment, the third threshold may be equal to the second threshold. The path switch request may be a PC5-S message and another PC5-S message may be used to reply a path switch accept.

UE2 may further check other conditions to accept the path switch request, e.g. the path switch (for a service) to Uu is allowed (according to the path switch policy) and/or UE2 is camping to a suitable cell (for UE in RRC_IDLE) or connecting to a serving cell (for UE in RRC_CONNECETD). In one embodiment, the path switch request message may include information indicating a set of services to be switched to the Uu path. And, the path switch accept message may include information indicating another set of services to be switched to the Uu path. The set of services included in the path switch accept message may be a subset of the set of services included in the path switch request message. Each set of services may include at least one service. The set of services included in the path switch accept message may be allowed to be switched to the Uu path according to the path switch policy. In one embodiment, UE2 in RRC_IDLE may need to establish a RRC connection with a gNB before replying a path switch accept to UE 1.

After the path switch request message is accepted, each UE could start Uu path preparation. For example, each UE could establish a RRC connection (if not yet established) with its serving gNB and establish a PDU session for the concerned service with the data network. DRBs to support the PDU session should also be established. After PDU sessions and related DRBs are established, both UEs may then communicate with each other via the established PDU sessions or the DRBs. The PC5 unicast link and/or all sidelink (or PC5) radio resources may then be released.

In one embodiment, the PC5 signal level may refer to the strength of a reference signal/discovery signal received from UE1 or UE2. And, the Uu signal level may refer to the strength of a reference signal received from its camping/serving cell.

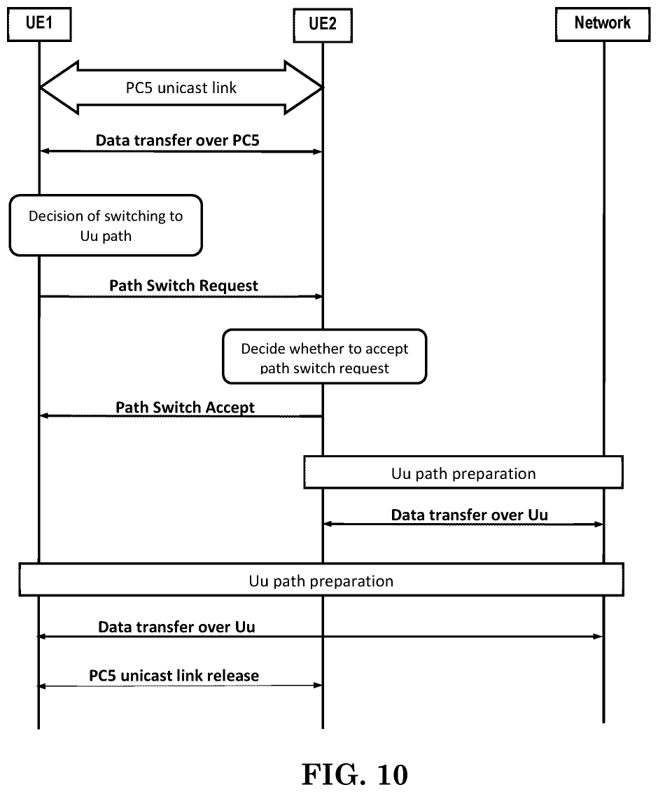

FIG. 10 illustrates an exemplary flow diagram of the above solution for a communication path switching from PC5 to Uu according to one embodiment.

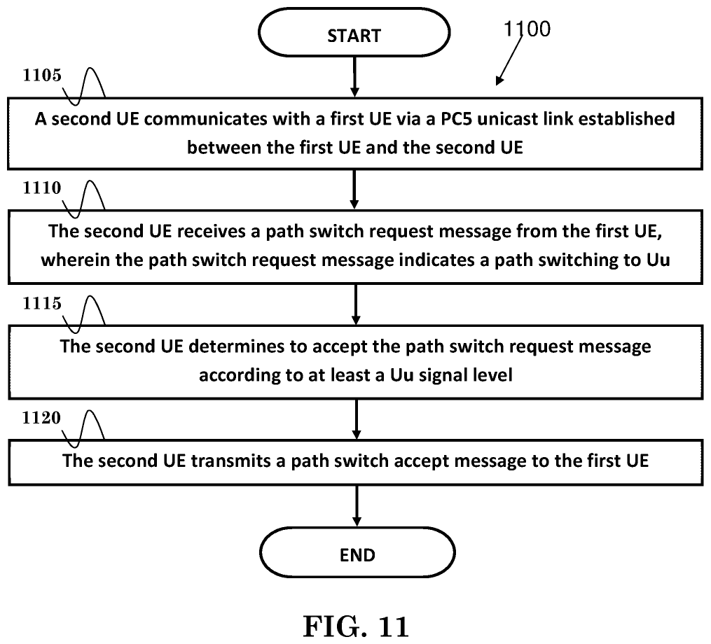

FIG. 11 is a flow chart 1100 illustrating an exemplary method for communication path switching from PC5 to Uu. In step 1105, a second User Equipment (UE) communicates with a first UE via a PC5 unicast link established between the first UE and the second UE. In step 1110, the second UE receives a path switch request message from the first UE, wherein the path switch request message indicates a path switching to Uu. In step 1115, the second UE determines to accept the path switch request message according to at least a Uu signal level. In step 1120, the second UE transmits a path switch accept message to the first UE.

In one embodiment, the second UE could determine to accept the path switch request message if the Uu signal level is higher than or equal to a first threshold, if the Uu signal level is higher than a PC5 signal level, or if the Uu signal level is higher than the PC5 signal level plus a second threshold. The PC5 signal level may refer to a strength of a reference signal or a discovery signal received from the second UE.

In one embodiment, the second UE could determine to accept the path switching to Uu if the path switch to Uu is allowed. The second UE could determine to accept the path switching to Uu if the second UE is camping to a suitable cell or connecting to a serving cell.

In one embodiment, the Uu signal level may refer to a strength of a reference signal received from a camping/serving cell of the second UE. The path switch request message may include information indicating a first set of services to be switched to Uu. The path switch accept message may also include information indicating a second set of services to be switched to Uu. The second set of services could be a subset of the first set of services. The second UE could determine to accept the path switching to Uu if at least a service in the first set of services is allowed to be switched to Uu.

Referring back to FIGS. 3 and 4, in one exemplary embodiment of a second UE, the second UE 300 includes a program code 312 stored in the memory 310. The CPU 308 could execute program code 312 to enable the second UE (i) to communicate with a first UE via a PC5 unicast link established between the first UE and the second UE, (ii) to receive a path switch request message from the first UE, wherein the path switch request message indicates a path switching to Uu, (iii) to determine to accept the path switch request message according to at least a Uu signal level, and (iv) to transmit a path switch accept message to the first UE. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for communication path switching from PC5 to Uu, comprising:
a second User Equipment (UE) communicates with a first UE via a PC5 unicast link established between the first UE and the second UE;
the second UE receives a path switch request message from the first UE, wherein the path switch request message indicates a path switching to Uu;
the second UE determines to accept the path switch request message according to at least a Uu signal level; and
the second UE transmits a path switch accept message to the first UE.

2. The method of claim 1, wherein the second UE determines to accept the path switch request message if the Uu signal level is higher than or equal to a first threshold, if the Uu signal level is higher than a PC5 signal level, or if the Uu signal level is higher than the PC5 signal level plus a second threshold.

3. The method of claim 2, wherein the PC5 signal level refers to a strength of a reference signal or a discovery signal received from the second UE.

4. The method of claim 1, wherein the second UE determines to accept the path switching to Uu if the path switch to Uu is allowed.

5. The method of claim 1, wherein the second UE determines to accept the path switching to Uu if the second UE is camping to a suitable cell or connecting to a serving cell.

6. The method of claim 1, wherein the Uu signal level refers to a strength of a reference signal received from a camping/serving cell of the second UE.

7. The method claim 1, wherein the path switch request message includes information indicating a first set of services to be switched to Uu.

8. The method of claim 7, wherein the path switch accept message includes information indicating a second set of services to be switched to Uu.

9. The method of claim 8, wherein the second set of services is a subset of the first set of services.

10. The method of claim 7, wherein the second UE determines to accept the path switching to Uu if at least a service in the first set of services is allowed to be switched to Uu.

11. A second User Equipment (UE), comprising:
a control circuit;
a processor installed in the control circuit; and
a memory installed in the control circuit and operatively coupled to the processor;
wherein the processor is configured to execute a program code stored in the memory to:
communicate with a first UE via a PC5 unicast link established between the first UE and the second UE;
receive a path switch request message from the first UE, wherein the path switch request message indicates a path switching to Uu;
determine to accept the path switch request message according to at least a Uu signal level; and
transmit a path switch accept message to the first UE.

12. The second UE of claim 11, wherein the second UE determines to accept the path switch request message if the Uu signal level is higher than or equal to a first threshold, if the Uu signal level is higher than a PC5 signal level, or if the Uu signal level is higher than the PC5 signal level plus a second threshold.

13. The second UE of claim 12, wherein the PC5 signal level refers to a strength of a reference signal or a discovery signal received from the second UE.

14. The second UE of claim 11, wherein the second UE determines to accept the path switching to Uu if the path switch to Uu is allowed.

15. The second UE of claim 11, wherein the second UE determines to accept the path switching to Uu if the second UE is camping to a suitable cell or connecting to a serving cell.

16. The second UE of claim 11, wherein the Uu signal level refers to a strength of a reference signal received from a camping/serving cell of the second UE.

17. The second UE of claim 11, wherein the path switch request message includes information indicating a first set of services to be switched to Uu.

18. The second UE of claim 17, wherein the path switch accept message includes information indicating a second set of services to be switched to Uu.

19. The second of UE of claim 18, wherein the second set of services is a subset of the first set of services.

20. The second UE of claim 17, wherein the second UE determines to accept the path switching to Uu if at least a service in the first set of services is allowed to be switched to Uu.
